(19) United States
(12) Patent Application Publication
(10) Pub. No.: US 2024/0377559 A1
(43) Pub. Date: Nov. 14, 2024

(54) ASPHERIC LENS WITH SOLID SHELL AND LIQUID INNER CORE

(71) Applicant: II-VI DELAWARE, INC., Wilmington, DE (US)

(72) Inventors: Li WU, Fuzhou (CN); Jianying ZHANG, Fuzhou (CN); Lei LIN, Fuzhou (CN); Guanglong YU, Fuzhou (CN)

(21) Appl. No.: 18/648,432

(22) Filed: Apr. 28, 2024

(30) Foreign Application Priority Data
May 12, 2023 (CN) 202310537665.5

(51) Int. Cl. G02B 3/12; B29D 11/00; G02B 1/06

(52) U.S. Cl. CPC G02B 3/12; B29D 11/0049; B29D 11/00951; G02B 1/06

(57) ABSTRACT

An optical lens includes an aspheric-shaped shell formed of an optical material, an optical plate connected to the aspheric-shaped shell, and a viscous fluid fluidically sealed in a cavity between the aspheric-shaped shell and the optical plate.

### CROSS-REFERENCE TO RELATED APPLICATIONS

The present application claims priority to Chinese Patent Application No. 202310537665.5, filed May 12, 2023. The aforementioned application is hereby incorporated by reference in its entirety.

### FIELD

The embodiments disclosed herein are in the field of optic devices used in optical systems, and methods for manufacturing optical devices. More particularly, the embodiments disclosed herein relate to optical lenses used in optical devices, systems, and methods.

### BACKGROUND

Unless otherwise indicated herein, the materials described herein are not prior art to the claims in the present application and are not admitted to be prior art by inclusion in this section.

Existing optical devices use optical lenses that are produced in an inefficient manner. Currently, the production of optical lenses is based upon direct optical processing of solid optical materials, which are costly to produce on a large scale. In some instances, grinding and polishing of solid optical materials, such as glass, is performed manually. Moreover, if at any point during the process of making the lens using the solid optical materials an error is made, then the lens is rendered useless resulting in a total loss of time and cost of materials to make the lens. Accordingly, improvements over prior art optical lens production processes are desired.

The subject matter claimed herein is not limited to implementations that solve any disadvantages or that operate only in environments such as those described above. Rather, this background is only provided to illustrate one example technology area where some implementations described herein may be practiced.

These and other advantages of the present invention will become more fully apparent from the detailed description of the invention herein below.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Embodiments are directed to an optical lens, methods for manufacturing an optical lens, and a system for maintaining pressure within an optical element.

In one example, an optical lens includes an aspheric-shaped shell formed of an optical material, an optical plate connected to the aspheric-shaped shell, and a viscous fluid fluidically sealed in a cavity between the aspheric-shaped shell and the optical plate.

In another aspect of the disclosure, in the optical lens, the optical plate is bonded to a circumferential region of the aspheric-shaped shell, and a portion of the circumferential region of the aspheric-shaped shell is spaced apart from the optical plate by a spacing.

In another aspect of the disclosure, in the optical lens, a capsule is attached to the second end of the aspheric shell within the spacing, and the capsule is in fluid communication with the viscous fluid.

In another aspect of the disclosure, in the optical lens, the capsule is configured to transport the viscous fluid into and out of the cavity based upon a temperature change of the optical lens.

In another aspect of the disclosure, in the optical lens, the capsule is configured to maintain a substantially constant pressure within the cavity over a range of operating temperatures of the optical lens.

In another example, a method for manufacturing an optical lens includes processing a sheet of optical material to form a plurality of aspheric-shaped shells, assembling the plurality of aspheric-shaped shells with an optical plate to produce a lens assembly, processing the lens assembly to produce a lens housing that includes a single one of the aspheric-shaped shells and a portion of the optical plate, and processing the lens housing by providing a viscous fluid within a cavity between the single one of the aspheric-shaped shells and the portion of the optical plate.

In another aspect of the disclosure, in the method for manufacturing, the processing a sheet of optical material comprises one of a press molding process and a vacuum molding process.

In another aspect of the disclosure, in the method for manufacturing, the press molding process includes placing the sheet of optical material between an upper platen and a lower platen, compressing the sheet of optical material between the upper platen and the lower platen, and molding the sheet of optical material to form the plurality of aspheric-shaped shells, in which an upper surface of the sheet of optical material comprises a contour profile of the upper platen and a lower surface of the sheet of optical material comprises a contour profile of the lower platen.

In another aspect of the disclosure, in the method for manufacturing, the contour profile of the upper platen compliments the contour profile of the lower platen.

In another aspect of the disclosure, in the method for manufacturing, the vacuum molding process includes placing the sheet of optical material onto a vacuum plate, reducing a pressure between the sheet of optical material and the vacuum plate, and molding the sheet of optical material to form the plurality of aspheric-shaped shells.

In another aspect of the disclosure, in the method for manufacturing, the molding the sheet of optical material to form the plurality of aspheric-shaped shells includes imparting a plurality of contours of the vacuum plate onto the sheet of optical material.

In another aspect of the disclosure, in the method for manufacturing, steps include processing the plurality of aspheric-shaped shells to reduce a material thickness of the sheet of optical material at locations between pairs of the aspheric-shaped shells, in which the assembling the plurality of aspheric-shaped shells with an optical plate to produce a lens assembly includes bonding the plurality of aspheric-shaped shells to the optical plate at locations other than the locations between pairs of the aspheric shells.

In another aspect of the disclosure, in the method for manufacturing, steps include providing a capsule to the lens housing, in which the capsule includes the viscous fluid.

In another example, a system for maintaining pressure within an optical element includes an optical lens comprising an aspheric-shaped shell formed of an optical material, an optical plate connected to the aspheric-shaped shell, and a viscous fluid fluidically sealed in a cavity between the aspheric-shaped shell and the optical plate, and a capsule attached to the optical lens, the capsule includes the viscous fluid, in which the capsule is configured to maintain a constant pressure within the cavity between the aspheric-shaped shell and the optical plate over a range of operating temperatures of the optical lens.

In another aspect of the disclosure, in the system for maintaining pressure within an optical element, the capsule is configured to maintain a constant pressure within the cavity between the aspheric-shaped shell and the optical plate by transport the viscous fluid into and out of the cavity based upon a temperature change of the optical lens.

In another aspect of the disclosure, in the system for maintaining pressure within an optical element, the optical plate is bonded to a circumferential region of the aspheric-shaped shell, and a portion of the circumferential region of the aspheric-shaped shell is spaced apart from the optical plate by a spacing comprising a portion of the capsule.

In another aspect of the disclosure, in the system for maintaining pressure within an optical element, the optical lens comprises a spacer disposed between the circumferential region of the aspheric-shaped shell and the optical plate, and a portion of the capsule is disposed within a channel formed in the spacer.

In another example, a method for manufacturing an optical lens includes processing a sheet of optical material to form a plurality of aspheric-shaped shells, processing the plurality of aspheric-shaped shells to produce individual ones of the aspheric-shaped shells, processing the individual ones of the aspheric-shaped shells by providing a viscous fluid into the individual ones of the aspheric-shaped shells, and providing, for each of the individual ones of the aspheric-shaped shells, a spherical lens, in which the viscous fluid is within a cavity between the aspheric-shaped shell and the spherical lens.

In another aspect of the disclosure, in the method for manufacturing, the processing a sheet of optical material to form a plurality of aspheric-shaped shells includes placing the sheet of optical material between an upper platen and a lower platen, compressing the sheet of optical material between the upper platen and the lower platen, and molding the sheet of optical material to form the plurality of aspheric-shaped shells, in which an upper surface of the sheet of optical material comprises a profile of the upper platen and a lower surface of the sheet of optical material comprises a profile of the lower platen.

In another aspect of the disclosure, in the method for manufacturing, the processing a sheet of optical material to form a plurality of aspheric-shaped shells includes placing the sheet of optical material onto a vacuum plate, reducing a pressure between the sheet of optical material and the vacuum plate, and molding the sheet of optical material to form the plurality of aspheric-shaped shells.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A and 1B are schematic diagrams illustrating an exemplary optical lens;

FIGS. 2A-2K are schematic diagrams illustrating an exemplary process for manufacturing the exemplary optical lens of FIGS. 1A and 1B;

FIGS. 3A and 3B are schematic diagrams illustrating another exemplary optical lens;

FIGS. 4A-4J are schematic diagrams illustrating an exemplary process for manufacturing the exemplary optical lens of FIGS. 3A and 3B;

FIGS. 5A-5E are schematic diagrams illustrating another exemplary process for manufacturing the exemplary optical lens of FIGS. 1A and 1B and FIGS. 3A and 3B; and

FIG. 6 is a schematic diagram illustrating another exemplary optical lens; and

FIGS. 7A-7C are schematic diagrams illustrating exemplary process for manufacturing the exemplary optical lens of FIG. 6.

### DETAILED DESCRIPTION

It is to be understood that the figures and descriptions of the present invention may have been simplified to illustrate elements that are relevant for a clear understanding of the present embodiments, while eliminating, for purposes of clarity, other elements found in an optical lens device, system using an optical lens device, and method for manufacturing an optical lens device. Those of ordinary skill in the art will recognize that other elements may be desirable and/or required to implement the present embodiments. However, because such elements are well known in the art, and because they do not facilitate a better understanding of the present embodiments, a discussion of such elements is not provided herein. It is also to be understood that the drawings included herewith only provide diagrammatic representations of the presently preferred structures of the present invention and that structures falling within the scope of the present embodiments may include structures different than those shown in the drawings. Reference will now be made to the drawings wherein like structures are provided with like reference designations.

As noted previously, existing methods for producing solid optical lenses comprising solid optical materials. In general, optical lens production is limited by the materials and processes used to manufacture solid optical lenses, in which the scale of production cannot be increased in a cost-effective manner.

Unless specific arrangements described herein are mutually exclusive with one another, the various implementations described herein can be combined in whole or in part to enhance system functionality or to produce complementary functions. Likewise, aspects of the implementations may be implemented in standalone arrangements. Thus, the below description has been given by way of example only and modification in detail may be made within the scope of the present invention.

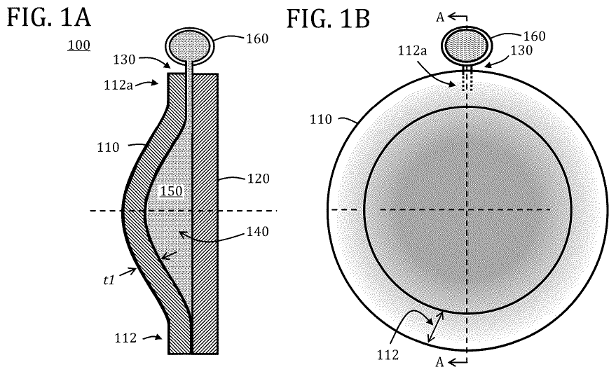

FIGS. 1A and 1B are schematic diagrams illustrating an exemplary optical lens, in which FIG. 1A is a cross-sectional view of FIG. 1B along A-A. In FIG. 1A, the optical lens 100 comprises an aspheric-shaped shell 110 having a circular shaped geometry. However, other geometries of the optical lens 100 and the aspheric-shaped shell 110 may be implemented.

In FIG. 1A, the aspheric-shaped shell 110 has a substantially uniform thickness t1. In some implementations, the substantially uniform thickness t1 of the aspheric-shaped shell 110 may be dependent upon a diameter of the optical lens 100, such that the optical lens 100 can bear the weight of the viscous fluid contained within the optical lens 100 without causing deformation of the optical lens 100. For example, the thickness t1 can be tens of microns to a few millimeters and can be up to a few centimeters, depending upon the diameter of the optical lens 100. The aspheric-shaped shell 110 includes a circumferential region 112 that may or may not have a thickness the same as the thickness t1. A portion 112a of the circumferential region 112 may include a channel 130 that passes between an exterior and an interior of the lens 100.

In FIG. 1A, the aspheric-shaped shell 110 may be coupled to an optical plate 120 along the circumferential region 112 of the aspheric-shaped shell 110. In some implementations, the circumferential region 112 may be attached to the optical plate 120 using known processes. For example, the circumferential region 112 may be attached to the optical plate 120 using a bonding or welding process. As an example, a welding process may include thin films formed on opposing surfaces of the circumferential region 112 and the optical plate 120, such as layers of chromium and gold, and using ultrasonic energy may be used to weld together the gold layers. Accordingly, attaching the circumferential region 112 with the optical plate 120 effectively seals the interior of the lens 100, with the exception of the channel 130. As a result, an interior cavity 140 is formed between the aspheric-shaped shell 110 and the optical plate 120. The interior cavity 140 is filled with a viscous fluid 150 that is transparent to a designed wavelength. By filling the cavity interior 140 with the viscous fluid 150, the lens 100 is not formed of solid optical material, thereby saving time as compared to manually forming the lens 100 completely from solid optical material(s).

The viscous fluid 150 is transparent to a designed wavelength. In some implementations, the viscous fluid 150 may comprise materials such as synthetic oil, alcohol, silicon oil, mineral oil, deionized water, and saline water. Additionally, the viscous fluid 150 may comprise one or more of these materials in combination, either as a mixture or separated into stratified layers. Accordingly, the materials implemented for the viscous fluid 150 may possess particular optical properties by which only a certain wavelength or wavelengths of light pass through. For example, the viscous fluid 150 may comprise materials that allow a wavelength range of 300-2200 nm, including the visible wavelength range of 400-700 nm, to pass through.

In FIG. 1A, the lens 100 includes a capsule 160 that is attached to the lens 100 within the channel 130 and is filled with the viscous fluid 150. Accordingly, the capsule 160 is connected to the interior cavity 140 via the channel 130 and is in fluid communication with the viscous fluid 150 to transport the viscous fluid 150 into and out of the interior cavity 140 based upon temperature change of the optical lens 100. Thermal expansion or contraction of the viscous fluid 150 within the interior cavity 140 due to a change of environmental conditions in which the lens 100 is operated can be accommodated by flow of the viscous fluid 150 into or out of the interior cavity 140 with respect to the capsule 160 via the channel 130. For example, as a temperature of the lens 100 increases, the viscous fluid 150 expands within the interior cavity 140 of the lens 100 and the pressure within the lens 100 increases. Accordingly, a volumetric amount of the viscous fluid 150 corresponding to the volumetric expansion of the viscous fluid 150 within the lens 100 may travel into the capsule 160 via the channel 130. Conversely, as a temperature of the lens 100 decreases, the viscous fluid 150 contracts within the interior cavity 140 of the lens 100 and the pressure within the lens 100 decreased. Accordingly, a volumetric amount of the viscous fluid 150 corresponding to the volumetric contraction of the liquid material 150 within the lens 100 may travel from the capsule 160 into the interior cavity 140 via the channel 130. Accordingly, the pressure within the interior cavity 140 of the lens 100 can be maintained within an operational temperature range of the lens 100 by movement of the viscous fluid 150 into/out of the interior cavity 140 of the lens 100 and out of/into the capsule 160. Moreover, since the pressure within the interior cavity portion 140 is held to be substantially constant, the shape of aspheric-shaped shell 110 will not change, thereby preventing changes in the optical properties of the lens 100.

In some implementations, the capsule 160 may comprise a single-walled structure formed from a compliant material. For example, the capsule 160 may be formed from a compliant material, which is capable of expanding to accommodate a volumetric amount of the viscous fluid 150 when the operational temperature of the lens 100 increases and the pressure within the interior cavity 140 increases. Additionally, the compliant material of the capsule 160 is capable of contracting to provide a volumetric amount of the viscous fluid 150 to the interior cavity 140 when the operational temperature of the lens 100 decreases and the pressure within the interior cavity 140 decreases.

In some implementations, the capsule 160 may comprise a double-walled structure. For example, the capsule 160 may have an inner wall formed from compliant material and an outer wall formed from rigid material, such as a plastic-type material. Accordingly, the inner wall is capable of expanding and contracting to accommodate a volumetric amount of the viscous fluid 150 when the operational temperature of the lens 100 changes and the pressure within the interior cavity 140 changes while the outer wall maintains a substantially constant exterior dimension. In some implementations, a compressible fluid or gas may be provided between the inner and outer walls of the capsule 160 to accommodate the expansion and the contraction of the inner wall.

In FIGS. 1A and 1B, although a single capsule 160 is depicted, additional capsules may be provided. For example, although not shown, a pair of capsules may be provided at multiple interfaces between the aspheric-shaped shell 110 and the optical plate 120 and at different radial locations of the lens 100. Additionally, although the capsule 160 is depicted to be located at a position between the aspheric-shaped shell 110 and the optical plate 120, the capsule 160 may be located at positions other than between the aspheric-shaped shell 110 and the optical plate 120. For example, in FIGS. 1A and 1B, the capsule 160 is oriented substantially parallel to the optical plate 120. However, the capsule 160 may be located at a position substantially perpendicular to the optical plate 120, with the channel 130 being formed at edge portions of the aspheric-shaped shell 110 and/or the optical plate 120.

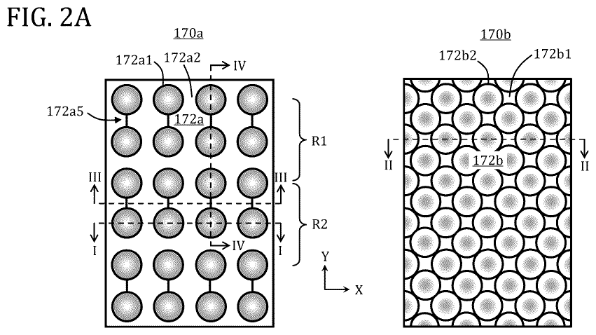

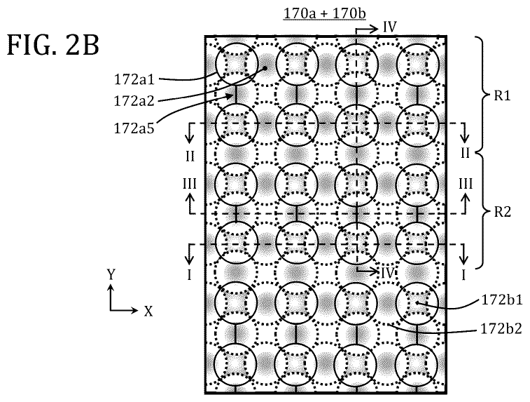

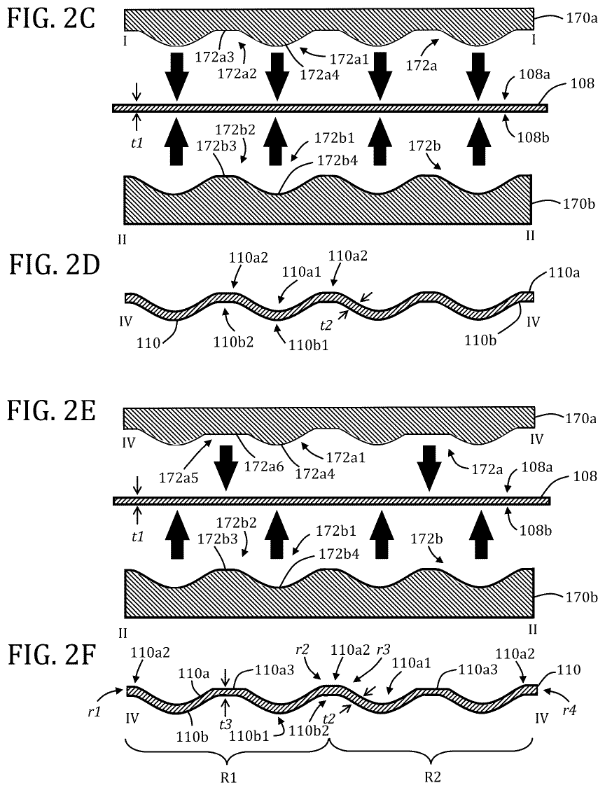

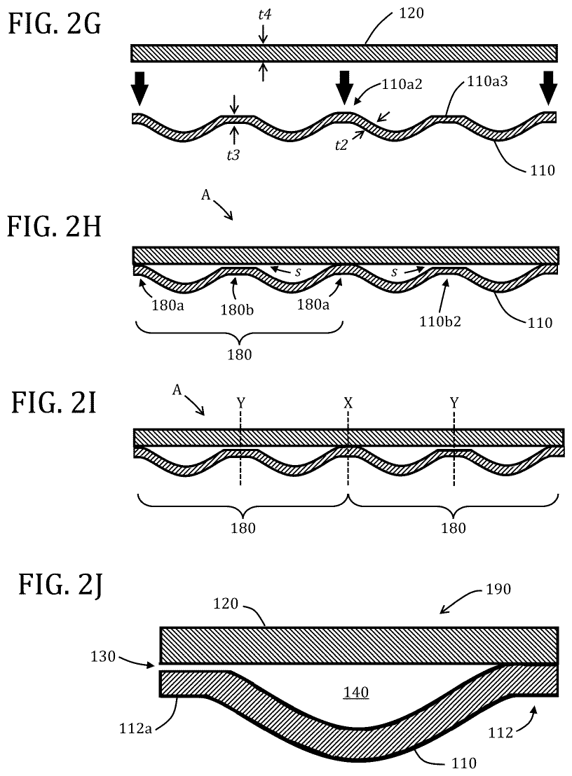

FIGS. 2A-2J are schematic diagrams illustrating an exemplary process for manufacturing the exemplary optical lens of FIGS. 1A and 1B. FIG. 2A is a plane view of exemplary molding platens. In FIG. 2A, exemplary molding platens 170a and 170b include contour profiles 172a and 172b, respectively. Molding platen 170a includes an interdigitated array of circular protrusions 172a1 and recesses 172a2 along both an x-direction (row) and a y-direction (column). Additionally, molding platen 170a includes an arrangement of linear protrusions 172a5 disposed selected ones of the circular protrusions 172a1 that extend along the column direction. In particular, the linear protrusions 172a5 are formed between pairs of the circular protrusions 172a1 along the row direction. For example, linear protrusions 172a5 are formed between first and second rows of the circular protrusions 172a1, but not between second and third rows of the circular protrusions 172a1. Molding platen 170b includes an arrangement of circular protrusions 172b2 and recesses 172b1 along both the row direction and the column direction.

FIG. 2B is a plane view of the molding platens 170a and 170b positioned in an overlapping configuration for a molding process. In FIG. 2B, for purposes of explanation, the molding platen 170a may be considered an upper molding platen and the molding platen 170b may be considered a lower molding platen. The upper molding platen 170a may include the array of circular protrusions 172a1 and recesses 172a2, along with the configuration of linear protrusions 172a5. The lower molding platen 170b may include the array of circular protrusions 172b2 and recesses 172b1. When the upper molding platen 170a and the lower molding platen 170b are positioned for the molding process, each of the circular protrusions 172a1 of the upper molding platen 170a are adjacent to at least four of the circular protrusions 172b2 of the lower molding platen 170b.

In FIG. 2B, the array of circular protrusions 172a1 and recesses 172a2 of the upper molding platen 170a are aligned with the array of recesses 172b1 and circular protrusions 172b2 of the lower molding platen 170b. In particular, the circular protrusions 172a1 of the upper molding platen 170a are aligned with the recesses 172b1 of the lower molding platen 170b, and the recesses 172a2 of the upper molding platen 170a are aligned with the circular protrusions 172b2 of the lower molding platen 170b. Additionally, the linear protrusions 172a5 of the upper platen 170a are aligned with the circular protrusions 172b2 of the lower molding platen 170b at alternating positions along the Y-direction. The linear protrusions 172a5 may be positioned between every two of the circular protrusions 172a1 along the Y-direction.

Although FIG. 2B may depict a particular geometric array of the circular protrusions 172a1 and recesses 172a2 of the upper molding platen 170a and a particular geometric array of the recesses 172b1 and circular protrusions 172b2 of the lower molding platen 170b, other geometric arrays are possible. Additionally, although FIG. 2B may depict a symmetrical arrangement of the circular protrusions 172a1 and recesses 172a2 of the upper molding platen 170a and a symmetrical arrangement of the recesses 172b1 and circular protrusions 172b2 of the lower molding platen 170b, asymmetrical arrangements are possible.

FIG. 2C is a cross-sectional view along I-I and II-II of FIGS. 2A and 2B, and FIG. 2E is cross-sectional view along IV-IV and II-II of FIGS. 2A and 2B. In FIG. 2C, an exemplary molding process includes placement of a sheet of optical material 108 between the upper molding platen 170a and the lower molding platen 170b. The sheet of optical material 108 may comprise various materials, such a glass, fused silica, quartz, polycarbonate, and acrylic.

In FIG. 2C, the upper molding platen 170a and the lower molding platen 170b may be implemented to impart the molding profile 172a of the upper molding platen 170a and the molding profile 172b of the lower molding platen 170b onto opposing sides 108a and 108b of the sheet of optical material 108. Here, pairs of protrusions/recesses 172a1/172b1 may have substantial complementary shapes, and pairs of recesses/protrusions 172a2/172b2 may have substantial complementary shapes.

In FIG. 2C, the recesses 172a2 of the upper molding platen 170a may have a substantially flat surface region 172a3 at a bottom region of the recesses 172a2, and the protrusions 172b2 of the lower platen 170b may have a substantially flat surface region 172b3 at a top region of the protrusions 172b2. The substantially flat surface regions 172a3 and 172b3 will coincide with the circumferential region 112 of the lens 100 (in FIG. 1A) when the lens 100 is formed from the sheet of optical material 108. Additionally, the circular protrusions 172a1 of the upper molding platen 170a may have a substantially curved surface region 172a4 at a top region of the circular protrusions 172a1, and the recesses 172b1 of the lower platen 170b may have a substantially curved surface region 172b4 at a bottom region of the recesses 172b1. The substantially curved surface region 172b4 may have a semi-hemispherical geometry, which will coincide with a curvature of the lens 100 (in FIG. 1A), when the lens 100 is formed from the sheet of optical material 108.

In FIG. 2E, the linear protrusions 172a5 of the upper molding platen 170a may have a substantially flat surface region 172a6 located at, and extend from, a bottom region corresponding to the recesses 172a2 (in FIG. 2C). Here, each of the linear protrusions 172a5 are positioned between every two of the circular protrusions 172a1. The linear protrusions 172a5 will coincide with the channel 130 of the lens 100 (in FIGS. 1A and 1B) when the lens 100 is formed from the sheet of optical material 108.

In FIGS. 2C and 2E, the sheet of optical material 108 may be preheated in order to increase pliability during the molding process. For example, the sheet of optical material 108 may be preheated in an oven to a temperature sufficient to soften the sheet of optical material 108. In some implementations, the sheet of optical material 108 may not require preheating, such that pliability of the sheet of optical material 108 at room temperate is sufficient for the molding process.

Additionally, the upper molding platen 170a and the lower molding platen 170b may both be heated using a thermal control system, not shown, as is known in the molding art. In some implementations, the molding temperature of the upper molding platen 170a and the lower molding platen 170b may be same or different. For example, the upper molding platen 170a and the lower molding platen 170b may be heated in accordance with the materials of the sheet of optical material 108, or the upper molding platen 170a and the lower molding platen 170b may remain at room temperature. Additionally, the molding temperature of the upper molding platen 170a and the lower molding platen 170b may be adjusted for the specific material(s) of sheet of optical material 108. For example, if the sheet of optical material 108 is a polycarbonate material, then the molding temperature of the upper molding platen 170a and the lower molding platen 170b may be lower than if the sheet of optical material 108 is a glass material.

Once the molding temperature of the upper molding platen 170a and the lower molding platen 170b has been attained, if heating is required, the sheet of optical material 108 may be pressed between the upper molding platen 170a and the lower molding platen 170b. The pressing of the sheet of optical material 108 by the upper molding platen 170a and the lower molding platen 170b may continue for a pre-selected amount of time and/or a pre-selected amount of molding pressure in order to impart the molding profile 172a of the upper molding platen 170a and the molding profile 172b of the lower molding platen 170b onto the opposing sides 110a and 110b of the sheet of optical material 108. In some implementations, the materials of the sheet of optical material 108 may dictate the pre-selected amount of time and/or the pre-selected amount of molding pressure.

FIG. 2D is a cross-sectional view of a formed optical sheet 110 from the molding process with respect to I-I and II-II of FIGS. 2A and 2B along the x-direction. In FIG. 2D, the formed optical sheet 110 comprises a plurality of flattened protrusions 110a2 and a plurality of curved recesses 110a1 configured in an alternating configuration along the x-direction (in FIGS. 2A and 2B) and formed on the side 110a of the formed optical sheet 110. The formed optical sheet 110 comprises a plurality of curved protrusions 110b1 and a plurality of flattened recesses 110b2 configured in an alternating configuration along the x-direction (in FIGS. 2A and 2B) and formed on the side 110b of the formed optical sheet 110. The plurality of flattened protrusions 110a2 oppose the plurality of flattened recesses 110b2. Of course, FIG. 2D depicts merely a representative portion of an overall formed optical sheet 110 along the X-direction, and a total number of the plurality of curved protrusions 110b1 and a plurality of flattened recesses 110b2 configured along the X-direction (in FIGS. 2A and 2B) may include more or less than those depicted in FIG. 2D.

In FIG. 2D, a thickness t2 of the formed optical sheet 110 may be substantially the same or substantially different as the thickness t1 of the sheet of optical material 108 prior to the molding process. In some implementations, the sheet of optical material 108 may comprise material that will accept a deformation change in thickness, such that the thickness t2 of the formed optical sheet 110 is less than the thickness t1 of the sheet of optical material 108. For example, since the sheet of optical material 108 is substantially flat, imparting the protrusions and recesses into the opposing sides 108a and 108b, may cause a reduction in the thickness t1, such that the thickness t2 is less than the thickness t1. In some implementations, the sheet of optical material 108 may comprise material that will not easily accept a deformation change in thickness, such that the thickness t2 of the formed optical sheet 110 is substantially the same as the thickness t1 of the sheet of optical material 108. For example, since the sheet of optical material 108 may be pliable, imparting the protrusions and recesses into the opposing sides 108a and 108b, may not cause a reduction in the thickness t1, such that the thickness t2 is substantially the same as the thickness t1.

FIG. 2F is a cross-sectional view of a formed optical sheet 110 from the molding process with respect to IV-IV and II-II of FIGS. 2A and 2B along the y-direction. In FIG. 2F, the formed optical sheet 110 comprises a plurality of the flattened protrusions 110a2 and a plurality of the curved recesses 110a1 configured in an alternating configuration along the y-direction (in FIGS. 2A and 2B) and formed on the side 110a of the formed optical sheet 110. The formed optical sheet 110 comprises a plurality of curved protrusions 110b1 and a plurality of flattened recesses 110b2 configured in an alternating configuration along the y-direction (in FIGS. 2A and 2B) and are formed on the side 110b of the formed optical sheet 110. However, located opposite to the recesses 110b2 formed on the side 110b of the formed optical sheet 110 between the circular protrusions 110a2 is a substantially flat surface 110a3 formed on the side 110a of the formed optical sheet 110. This substantially flat surface 110a3 corresponds to the linear protrusion 172a5 of the upper molding platen 170a (in FIG. 2E). The thickness t2 of the formed optical sheet 110 is substantially uniform, but a thickness t3 of the formed optical sheet 110 between the side 110b of the formed optical sheet 110 and the substantially flat surface 110a3 is less than the thickness t2.

In FIG. 2F, a row R1 of the formed optical sheet 110 includes a pair of curved protrusions 110b1 connected to the substantially flat surface 110a3 and located between a portion of the flattened protrusion 110a2 at a first region r1 and a portion of the flattened protrusion 110a2 at a second region r2. A row R2 of the formed optical sheet 110 includes a pair of the curved protrusions 110b1 connected to the substantially flat surface 110a3 and located between a portion of the flattened protrusion 110a2 at a third region r3 and a portion of the flattened protrusion 110a2 at a fourth region r4. Of course, FIG. 2F depicts merely a representative portion of an overall formed optical sheet 110, with the rows R1 and R2 being periodically repeated along the Y-direction, and a total number of the plurality of flattened protrusions 110a2 and 110a3 configured along the Y-direction (in FIGS. 2A and 2B) may include more or less than those depicted in FIG. 2F.

FIG. 2G is a cross-sectional view of the formed optical sheet 110 from the molding process with respect to IV-IV and II-II of FIGS. 2A and 2B along the y-direction. In FIG. 2G, an optical plate 120 is attached to the formed optical sheet 110 at the flattened protrusions 110a2. Although the optical plate 120 may be depicted as having a thickness t4 greater than the thicknesses 12 and 3 of the formed optical sheet 110, the thickness t4 may be the same, more, or less that either of the thicknesses t2 and 13 of the formed optical sheet 110.

FIG. 2H is a cross-sectional view of the formed optical sheet 110 from the molding process with respect to IV-IV and II-II of FIGS. 2A and 2B along the y-direction. In FIG. 2H, the optical plate 120 is attached to the formed optical sheet 110 at the flattened protrusions 110a2, in which a spacing s is provided between the optical plate 120 and the flattened protrusions 110a3 of the formed optical sheet 110 (in FIG. 2F). After the optical plate 120 is attached to the formed optical sheet 110 at the flattened protrusions 110a2, an optical assembly A is formed that includes lens sets 180 that each comprise ends 180a attached to the optical plate 120 with a central portion 180b spaced apart from the optical plate 120.

FIG. 2I is a cross-sectional view of the optical assembly A. In FIG. 2I, the optical assembly A may be processed by dividing the optical assembly A at line X in order to form individual ones of the lens sets 180. Additionally, the individual ones of the lens sets 180 may be divided at line Y in order to form separate lens bodies 190 (in FIG. 2J). In some implementations, dividing the optical assembly A at line X in order to form individual ones of the lens sets 180 may be performed by a cutting process, and the individual ones of the lens sets 180 may be divided at line Y in order to form separate lens bodies 190 (in FIG. 2J) using a cutting process. Here, the order by which the cutting processes at line X and line Y may be in any order.

FIG. 2J is cross-sectional view of the lens body 190. In FIG. 2J, the lens body 190 includes a circumferential region 112 of an aspheric-shaped shell 110, as from the formed optical sheet 110, attached to the optical plate 120 and a portion 112a of the circumferential region 112 may include a channel 130 that passes between an exterior and an interior of the lens body 190.

FIG. 2K is a cross-sectional view of the lens body 190 during a filling process. In FIG. 2K, a cavity 140 of the lens body 190 is substantially filled with a viscous fluid 150. In some implementations, the interior cavity 140 may be filled with the viscous fluid 150 by pouring or injecting the viscous fluid 150 from a container system D into the interior cavity 140 until the interior cavity 140 is substantially filled with the viscous fluid 150. In other implementations, a pump may be used to fill the interior cavity 140 with the viscous fluid 150.

Once the cavity 140 has been substantially filled with a specific amount of the viscous fluid 150, the filling stops and a neck portion 162 of a capsule 160 is inserted into the channel 130. Here, the capsule 160 is filled with the viscous fluid 150, as discussed above with respect to FIGS. 1A and 1B, and the neck portion 162 of the capsule is attached to the lens body 190 at the aspherical-shaped shell 110. In some implementations, the neck 162 of the capsule 160 may be bonded within the channel 130. For example, the neck 162 of the capsule 160 may be attached within the channel 130 using an adhesive applied to the neck 162 prior to insertion into the through-hole 130. Alternatively, the neck 162 of the capsule 160 may be inserted into the channel 130 and an adhesive can be applied at an exterior of the neck 162 adjacent to a portion 112a of the circumferential region 112 of the aspheric-shaped shell 102 and the optical plate 120.

Here, although some amount of air will not substantially alter the lens 100, it may be desirable to ensure that air is excluded from within the cavity 140, as well as regions between the cavity 140 and the capsule 160. As a result of the process, a lens 100 is formed comprising the aspherical-shaped shell 110 attached to the optical plate 120, with the viscous fluid 150 in communication with the capsule 160.

Additionally, although not shown, a mechanism for adjusting pressure imparted to the interior cavity 140 by attaching the capsule 160 to the lens housing 190 may be provided. For example, a mechanism can be implemented with the capsule 160 to release pressure caused by attaching the capsule 160 to the lens housing 190 and bring a final pressure of the interior cavity 140 to substantially atmospheric pressure and temperature, or to a pre-set pressure and temperature.

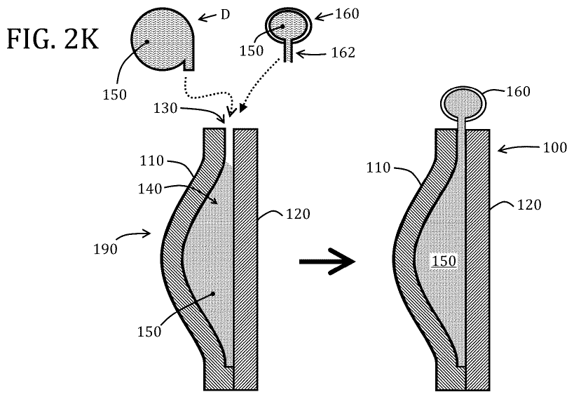

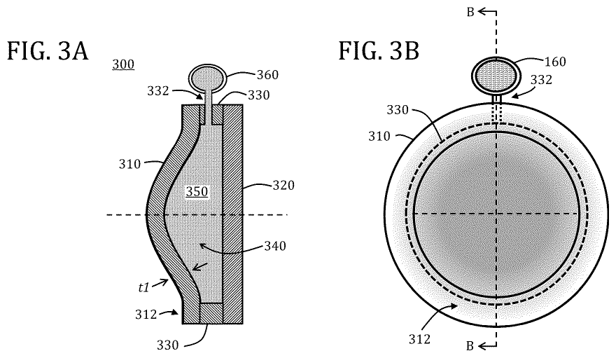

FIGS. 3A and 3B are a schematic diagrams illustrating another exemplary optical lens. In FIG. 3A, the optical lens 300 comprises an aspheric-shaped shell 310 having substantially uniform thickness t1. In some implementations, the substantially uniform thickness t1 of the aspheric-shaped shell 310 may be within a particular range. For example, as discussed above, the thickness t1 can be dependent upon a diameter of the optical lens 100, and can be tens of microns to a few millimeters and can be up to a few centimeters.

In FIG. 3A, the aspheric-shaped shell 310 may be coupled to an optical plate 320 with a spacer 330 in between a circumferential region 312 of the aspheric-shaped shell 310. In some implementations, the spacer 330 has a generally circular shape, such as washer, in which an open central region is aligned with the optical axis the aspheric-shaped shell 310, and a diametric perimeter that substantially aligns with the circumferential region 312 of the aspheric-shaped shell 310. The spacer 330 may be formed from materials of the aspheric-shaped shell 310 and/or the optical plate 320. In particular, materials of the spacer 300, the aspheric-shaped shell 310, and the optical plate 320 should be formed of the same materials having substantially the same coefficient of thermal expansion (CTE).

Attachment of the spacer 330 with the circumferential region 312 of the aspheric-shaped shell 310, as well as attachment of the spacer 330 with the optical plate 320, may be made using known processes. For example, the circumferential region 312 of the aspheric-shaped shell 310 may be attached to the spacer 330 and attachment of the spacer 330 with the optical plate 320 may both include bonding or welding processes. Accordingly, the circumferential region 312 of the aspheric-shaped shell 310, the spacer 330, and the optical plate 120 form a sealed interior cavity 340 between the aspheric-shaped shell 310 and the optical plate 320. The interior cavity 340 is filled with a viscous material 350 that is transparent to a designed wavelength. By filling the interior cavity 340 with the viscous material 350, the lens 300 is not formed of solid optical material(s), thereby saving time as compared to manually forming the lens 300 completely from a solid optical material. The viscous fluid 350 is transparent to a designed wavelength. In some implementations, the viscous fluid 350 may be similar to the viscous fluid 150 (in FIGS. 1A and 1B).

In FIG. 3, the lens 300 includes a capsule 360 that is subsequently attached to the lens 300 at a channel 332 formed at a specific location in the spacer 330 and is filled with the viscous fluid 350, whereby the capsule 360 is connected to the interior cavity 340 via the channel 332 and is in fluid communication with the viscous fluid 350 to transport the viscous fluid 350 into and out of interior cavity 340 based upon temperature change of the optical lens 300. The channel 332 can be formed in the spacer 330 prior to, or after, positioning between the aspherical-shaped shell 310 and the optical plate 320.

Thermal expansion or contraction of the viscous fluid 350 within the interior cavity 340 due to a change of environmental conditions in which the lens 300 is operated can be accommodated by flow of the viscous fluid 350 into or out of the interior cavity 340 with respect to the capsule 360 via the channel 332. For example, as a temperature of the lens 300 increases, the viscous fluid 350 expands within the interior cavity 340 of the lens 300 and the pressure within the lens 300 increases. Accordingly, a volumetric amount of the viscous fluid 350 corresponding to the volumetric expansion of the viscous fluid 350 within the lens 300 may travel into the capsule 360 via the through-hole 332. Conversely, as a temperature of the lens 300 decreases, the viscous fluid 350 contracts within the interior cavity 340 of the lens 300 and the pressure within the lens 300 decreased. Accordingly, a volumetric amount of the viscous fluid 350 corresponding to the volumetric contraction of the viscous fluid 350 within the lens 300 may travel from the capsule 360 into the interior cavity 340 via the channel 332. Accordingly, the pressure within the interior cavity 340 of the lens 300 can be held substantially constant within an operational temperature range of the lens 300 by movement of the viscous fluid 350 into/out of the interior cavity 340 of the lens 300 and out of/into the capsule 360. Moreover, since the pressure within the interior cavity 340 is held to be substantially constant, the shape of aspheric-shaped shell 310 will not change, thereby preventing changes in the optical properties of the lens 300.

In some implementations, the capsule 360 may comprise a single-walled structure formed from a compliant material. For example, the capsule 360 may be formed from a rubber-like material, which is capable of expanding to accommodate a volumetric amount of the viscous fluid 350 when the operational temperature of the lens 300 increases and the pressure within the interior cavity 340 increases. Additionally, the rubber-like material of the capsule 360 is capable of contracting to provide a volumetric amount of the viscous fluid 350 to the interior cavity 340 when the operational temperature of the lens 300 decreases and the pressure within the interior cavity 340 decreases.

In some implementations, the capsule 360 may comprise a double-walled structure. For example, the capsule 360 may have an inner wall formed from compliant material and an outer wall formed from rigid material, such as a plastic-type material. Accordingly, the inner wall is capable of is capable of expanding and contracting to accommodate a volumetric amount of the viscous fluid 350 when the operational temperature of the lens 300 changes and the pressure within the interior cavity 340 changes while the outer wall maintains a substantially constant exterior dimension.

In FIG. 3, although a single capsule 360 is depicted, additional capsules may be provided. For example, although not shown, a pair of capsules may be provided at each of the spacers 320. Additionally, although the capsule 360 is depicted to be located at a position within the spacer 330, the capsule 360 may be located at positions other than within the spacer 330. For example, in FIG. 3, the capsule 360 is oriented substantially parallel to the optical plate 320. However, the capsule 360 may be located at a position substantially perpendicular to the optical plate 320.

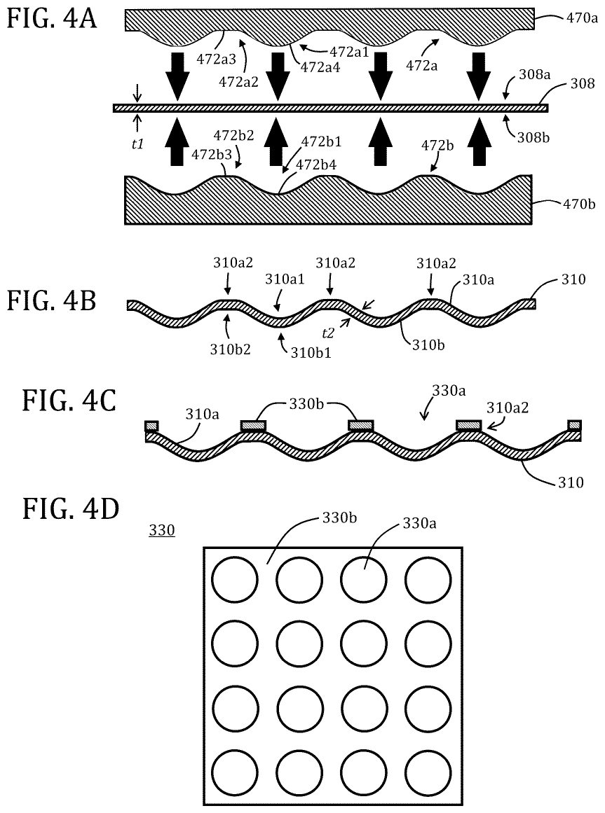

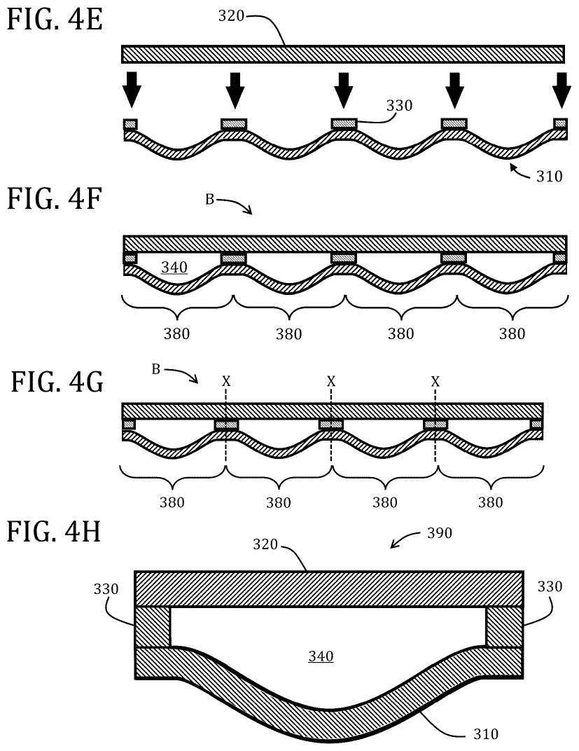

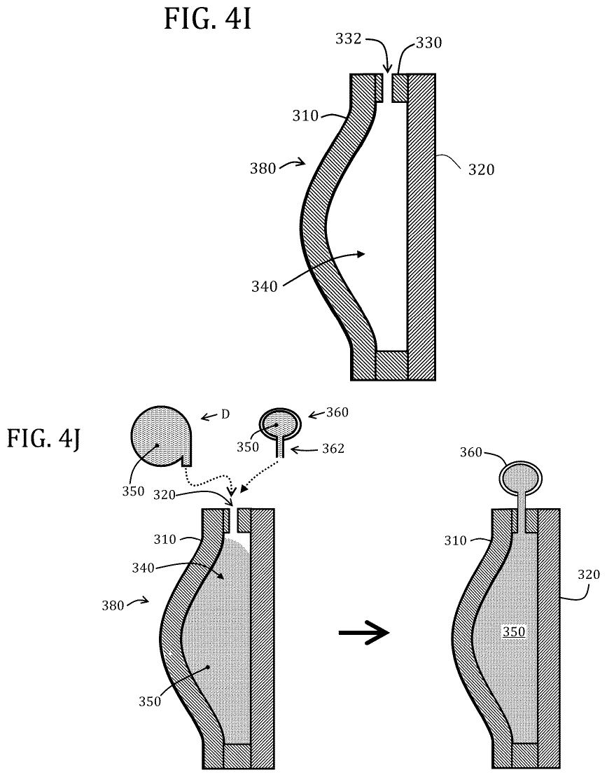

FIGS. 4A-4H are schematic diagrams illustrating an exemplary process for manufacturing the exemplary optical lens of FIG. 3. In FIGS. 4A-4H, an exemplary molding process is depicted in which a sheet of optical material 308 is positioned between an upper molding platen 470a and a lower molding platen 470b. Although FIG. 4A may depict that the upper molding platen 470a includes a molding profile 472a having several contours and the lower molding platen 470b includes a molding profile 472b having several contours, in actuality the molding profile 472a of upper molding platen 470a and the molding profile 472b of the lower molding platen 470b includes many contours. For example, a size of the upper molding platen 470a and the lower molding platen 470b, as well as a size of the sheet of optical material 308, can be scaled in order to produce any number of contours.

In FIG. 4A, the upper molding platen 470a and the lower molding platen 470b may be implemented to impart the molding profile 472a of the upper molding platen 470a and the molding profile 472b of the lower molding platen 470b onto opposing sides 308a and 308b of the sheet of optical material 308. Here, pairs of protrusions/recesses 472a1/472b1 may have substantial complementary shapes, and pairs of recesses/protrusions 472a2/472b2 may have substantial complementary shapes.

In FIG. 4A, the recesses 472a2 of the upper molding platen 470a may have a substantially flat surface region 472a3 at a bottom region of the recesses 472a2, and the protrusions 472b2 of the lower platen 470b may have a substantially flat surface region 472b3 at a top region of the protrusions 472b2. The substantially flat surface regions 472a3 and 472b3 will coincide with the circumferential region 312 of the lens 300 (in FIG. 3A) when the lens 300 is formed from the sheet of optical material 108. Additionally, the circular protrusions 472a1 of the upper molding platen 470a may have a substantially curved surface region 472a4 at a top region of the circular protrusions 472a1, and the recesses 472b1 of the lower platen 470b may have a substantially curved surface region 472b4 at a bottom region of the recesses 472b1. The substantially curved surface region 472b4 may have a semi-hemispherical geometry, which will coincide with a curvature of the lens 300 (in FIG. 3A), when the lens 300 is formed from the sheet of optical material 308.

In FIG. 4A, the sheet of optical material 308 may be preheated in order to increase pliability during the molding process. The sheet of optical material 308 may comprise material(s) similar to those of the sheet of optical material 108 (in FIGS. 2C and 2E). For example, the sheet of optical material 308 may be preheated in an oven to a temperature sufficient to soften the sheet of optical material 308. In some implementations, the sheet of optical material 308 may not require preheating, such that pliability of the sheet of optical material 308 at room temperate is sufficient for the molding process.

Additionally, the upper molding platen 470a and the lower molding platen 470b may both be heated using a thermal control system, not shown, as is known in the molding arts. In some implementations, the molding temperature of the upper molding platen 470a and the lower molding platen 470b may be same or different. For example, the upper molding platen 470a and the lower molding platen 470b may be heated in accordance with the materials of the sheet of optical material 108, or the upper molding platen 170a and the lower molding platen 170b may remain at room temperature. Additionally, the molding temperature of the upper molding platen 470a and the lower molding platen 470b may be adjusted for the specific material(s) of sheet of optical material 308. For example, if the sheet of optical material 308 is a polycarbonate material, then the molding temperature of the upper molding platen 470a and the lower molding platen 470b may be lower than if the sheet of optical material 308 is a glass material.

Once the molding temperature of the upper molding platen 470a and the lower molding platen 470b has been attained, the sheet of optical material 308 may be pressed between the upper molding platen 470a and the lower molding platen 470b. The pressing of the sheet of optical material 308 by the upper molding platen 470a and the lower molding platen 470b may continue for a pre-selected amount of time in order to impart the molding profile 472a of the upper molding platen 470a and the molding profile 472b of the lower molding platen 470b onto opposing sides 308a and 308b of the sheet of optical material 308. In some implementations, the materials of the sheet of optical material 308 may dictate the pre-selected amount of time.

In FIG. 4B, after the pre-selected time, the upper molding platen 470a can be withdrawn from the sheet of optical material 308, and the formed optical sheet 310 may be removed from the lower molding platen 470b. A thickness t1 between the opposing sides 310a and 310b of the formed optical sheet 310 may be substantially uniform.

In some implementations, the formed optical sheet 310 may be allowed to cool while remaining on the lower molding platen 470b in order to retain the contours impart to the opposing surfaces 310a and 310b of the formed optical sheet 310. Additionally, any release agents used during the molding process may be cleaned from the opposing surfaces 310a and 310b of the formed optical sheet 310 immediately after molding, or may be cleaned from the opposing surfaces 310a and 310b of the formed optical sheet 310 further during the manufacturing process.

In FIG. 4B, the formed optical sheet 310 comprises a plurality of flattened protrusions 310a2 and a plurality of curved recesses 310a1 configured in an alternating configuration along the x-direction (in FIGS. 2A and 2B) and formed on the side 310a of the formed optical sheet 310. The formed optical sheet 310 comprises a plurality of curved protrusions 310b1 and a plurality of flattened recesses 310b2 configured in an alternating configuration along the x-direction (in FIGS. 2A and 2B) and formed on the side 310b of the formed optical sheet 310. The plurality of flattened protrusions 310a2 oppose the plurality of flattened recesses 310b2. Of course, FIG. 4B depicts merely a representative portion of an overall formed optical sheet 310 along the X-direction, and a total number of the plurality of curved protrusions 310b1 and a plurality of flattened recesses 310b2 configured along the X-direction (in FIGS. 2A and 2B) may include more or less than those depicted in FIG. 4A.

In FIG. 4B, a thickness t2 of the formed optical sheet 310 may be substantially the same or substantially different as the thickness t1 of the sheet of optical material 308 prior to the molding process. In some implementations, the sheet of optical material 308 may comprise material that will accept a deformation change in thickness, such that the thickness t2 of the formed optical sheet 310 is less than the thickness t1 of the sheet of optical material 308. For example, since the sheet of optical material 308 is substantially flat, imparting the protrusions and recesses into the opposing sides 308a and 308b, may cause a reduction in the thickness t1, such that the thickness t2 is less than the thickness t1. In some implementations, the sheet of optical material 308 may comprise material that will not easily accept a deformation change in thickness, such that the thickness t2 of the formed optical sheet 310 is substantially the same as the thickness t1 of the sheet of optical material 308. For example, since the sheet of optical material 308 may be pliable, imparting the protrusions and recesses into the opposing sides 308a and 308b, may not cause a reduction in the thickness t1, such that the thickness t2 is substantially the same as the thickness t1.

In FIG. 4C, a spacer material 330 may be positioned on the flattened protrusions 310a2 of the formed optical sheet 310. In some implementations, the spacer material 330 may comprise a sheet of spacer material 330, in which circular openings 330a in the sheet of spacer material 330 may align with the flattened protrusions 310a2. For example, as shown in FIG. 4D, the sheet of spacer material 330 comprises an array of holes 330a formed with web portions 330b in between. Accordingly, the web portions 330b are provided on the flattened protrusions 310a2 and the holes 330a being aligned with the recesses 310a1, wherein the web portions 330b will subsequently become the spacers 330 provided at the circumferential region 312 of the lens 300 (in FIG. 3).

In FIG. 4E, an optical plate 320 is positioned over the spacer material 330. Then, the formed optical sheet 310, the spacer material 330, and the optical plate 320 are attached together to form an optical assembly B. In some implementations, a bonding or welding process may be implemented. For example, an ultrasonic welding process may be used by which thin films are formed on opposing surfaces of the formed optical sheet, the spacer material 330, and the optical plate 320, such as layers of chromium and gold, and then welded together using ultrasonic energy to attached together the gold layers.

In FIG. 4F, an optical assembly B is formed comprising individual lens sets 380, each having a sealed interior cavity 340 between the formed optical sheet 310 and the optical plate 320.

In FIG. 4G, the optical assembly B is cut along lines X to divide the lens sets 380 into individual lens housings 390.

In FIG. 4H, each of the lens housings 390 includes an aspheric-shaped shell 310 attached to the optical plate 320 with the spacer 330 in between, and further includes a sealed interior cavity 340.

In FIG. 4I, a channel 332 is formed in the spacer 330. In some implementations, forming the channel 332 in the spacer 330 may be accomplished by removing portions of the spacer 330. For example, a drill (or laser) can be used to remove portions of the spacer 330 in order to form the channel 332. Additionally, other processes can be used to form the channel 332 in the spacer based upon the material(s) of the spacer 330.

In FIG. 4J, the interior cavity 340 is substantially filled with a viscous fluid 350 supplied via the channel 332. In some implementations, the interior cavity 340 may be filled with the viscous fluid 350 by pouring or injecting the viscous fluid 350 from a container system D into the interior cavity 340 until the interior cavity 340 is substantially filled with the viscous fluid 350. In other implementations, a pump may be used to fill the interior cavity 340 with the viscous fluid 350.

After the cavity 340 is substantially filled with the viscous fluid 350, a capsule 360 is inserted into the channel 332. In some implementations, a neck 362 of the capsule 360 may be bonded within the channel 332. For example, the neck 362 of the capsule 360 may be attached within the channel 332 using an adhesive applied to the neck 362 prior to insertion into the channel 332. Alternatively, the neck 362 of the capsule 360 may be inserted into the channel 332 and an adhesive can be applied at an exterior of the neck 362 adjacent to the spacer 330.

Additionally, although not shown, a mechanism for adjusting pressure imparted to the interior cavity 340 by attaching the capsule 360 to the lens housing 380 may be provided. For example, a mechanism can be implemented with the capsule 360 to release pressure caused by attaching the capsule 360 to the lens housing 380, and bring a final pressure of the interior cavity 340 to substantially atmospheric pressure and atmospheric temperature.

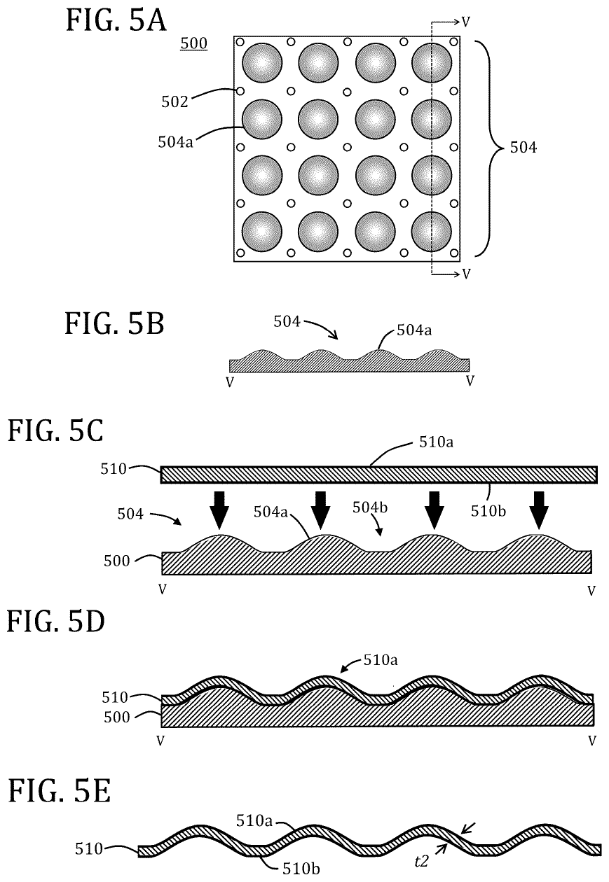

FIGS. 5A-5E are schematic diagrams illustrating another exemplary process for manufacturing the exemplary optical lens 100 and 300 of FIGS. 1 and 3. The vacuum forming process of FIGS. 5A-5E may be substituted for the molding processes of FIGS. 2A-2E, and 4A and 4B, to produce the formed optical sheet 110 (in FIGS. 2D and 2F) and formed optical sheet 310 (in FIG. 4B).

In FIG. 5A, a vacuum forming process is implemented using a vacuum plate 500 comprising an array of vacuum ports 502 and an array of circular protrusions 504a. In FIG. 5B, a cross-sectional view along V-V of FIG. 5A, depicts the array of circular protrusions 504a of the vacuum plate 500. In FIGS. 5A and 5B, although the vacuum plate 500 may be depicted having an array 504 of several circular protrusions 504a, in actuality the vacuum plate 500 may include a large or a smaller array 504 of the circular protrusions 504a. For example, a size of the vacuum plate 500, as well as a size of the sheet of optical material 510, can be scaled in order to produce any number of the circular protrusions 504a.

In FIG. 5C, a sheet of optical material 510 is provided over the vacuum plate 500. A negative pressure force, i.e., a vacuum, is provided through the vacuum ports 502 in order to draw-in a surface 510b of the sheet of optical material 510 onto a surface 504b of the vacuum plate 500. Although not shown, a vacuum plate frame may be provided along a perimeter of the vacuum plate 500 to mechanically affix the sheet of optical material 510 at the perimeter of the vacuum plate 500 to form an air-tight seal between the sheet of optical material 510 and the vacuum plate 500.

In FIG. 5D, upon achieving sufficient negative pressure force, the surface 510a of the sheet of optical material 510 is pressed against the surface 504b of the vacuum plate 500 and the array 504 of the protrusions 504a of the vacuum plate 500. Accordingly, the sheet of optical material 510 is molded with the array 504 of the protrusions 504a of the vacuum plate 520. The sheet of optical material 510 may comprise materials similar to the sheet of optical materials 110 and 310 (in FIGS. 2C, 2E, and 4A).

In FIG. 5C, the sheet of optical material 510 may be preheated prior to molding in order to increase pliability during the molding process. For example, the sheet of optical material 510 may be preheated similar to that of the sheet of optical material 108 (in FIGS. 2C and 2E) and the sheet of optical material 308 (in FIG. 4A). However, since the vacuum molding process of FIG. 5C is different from the press molding processes of FIGS. 2C, 2E, and 4A, preheating the sheet of optical material 510 may be higher or lower from the sheet of optical material 108 (in FIGS. 2C and 2E) and the sheet of optical material 308 (in FIG. 4A).

Additionally, the vacuum plate 500 may be heated using a thermal control system, not shown, as is known in the molding arts. In some implementations, the temperature of the vacuum plate 500 may be adjusted for the specific material(s) of sheet of optical material 510. For example, if the sheet of optical material 510 is a polycarbonate material, then the temperature of the vacuum plate 500 may be lower than if the sheet of optical material 510 is a glass material.

In FIG. 5E, once the sheet of optical material 510 has been pressed against the array 504 of the protrusions 504a formed on the vacuum plate 500 for a pre-selected amount of time in order to impart the circular protrusions 504a of the vacuum plate 500 onto the surface 510b of the sheet of optical material 510, the supplied negative pressure may be removed and the formed optical sheet 510 may be removed from the vacuum plate 500. In some implementations, the materials of the sheet of optical material 510 may determine the pre-selected amount of time. A thickness t2 between the opposing surfaces 510b and 510a of the formed optical sheet 510 may be substantially uniform.

In some implementations, the formed optical sheet 510 may be allowed to cool while remaining on the vacuum plate 500 in order to retain the contours impart to the opposing side surfaces 510a and 510b of the formed optical sheet 510. Additionally, any release agents used during the vacuum molding process may be cleaned from the opposing surfaces 510a and 510b of the formed optical sheet 510 immediately after vacuum molding, or may be cleaned from the opposing surfaces 510a and 510b of the formed optical sheet 510 during further fabrication processes. From here, the formed optical sheet 510 may be implemented in the processes of FIG. 4C-4J, to produce the lens housing 390 (in FIG. 4H).

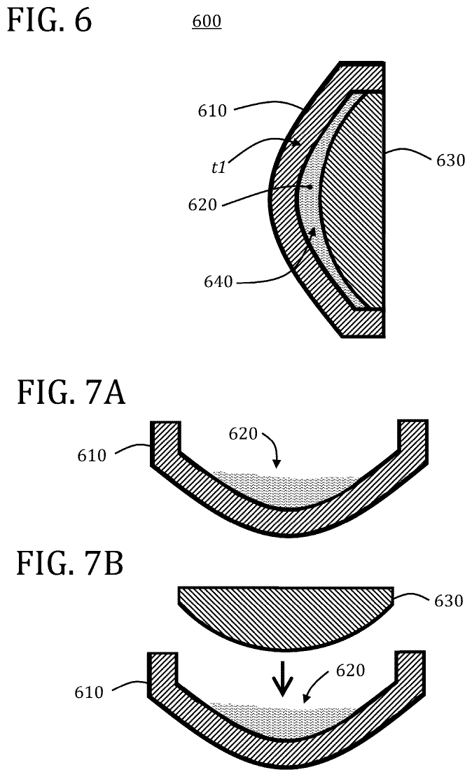

FIG. 6 is a schematic diagram illustrating another exemplary optical lens. In FIG. 6, the optical lens 600 includes an aspherical-shaped shell 610 and a spherical lens 630 with a viscous fluid 620 provided in between. In some implementations, the aspherical-shaped shell 610 may be produced using any of the processes shown in FIGS. 4 and 5. For example, the upper molding platen 170a and the lower molding platen 170b (in FIG. 2A) or the upper molding platen 470a and the lower molding platen 470b (in FIG. 4A) can be modified in order to provide contours that result in formation of the aspherical-shaped shell 610. Additionally, the array of circular protrusions 504a of the vacuum plate 500 (in FIG. 5) can be modified to provide the aspherical-shaped shell 610.

When the spherical lens 630 is assembled with the aspherical-shaped shell 610 and the spherical lens 630 is inserted into the aspherical-shaped shell 610, a bonding seal may be formed between the spherical lens 630 and the aspherical-shaped shell 610. In some implementations, a bonding agent may be used to ensure a permanent seal between the spherical lens 630 and the aspherical-shaped shell 610.

Prior to assembling the spherical lens 630 and the aspherical-shaped shell 610, a volumetric amount of the viscous fluid 620 is provided within the aspherical-shaped shell 610. Then, the spherical lens 630 is inserted into the aspherical-shaped shell 610, and the viscous fluid 620 is distributed with the cavity 640 between the spherical lens 630 and the aspherical-shaped shell 610. Accordingly, the spherical lens 630 and the aspherical-shaped shell 610 may be sealed together using a bonding process, such as an adhesive. The viscous fluid 150 may comprise material similar to the viscous fluids 150 and 350 (in FIGS. 1A and 3A).

In some implementations, the lens 600 may be substantially larger than the lenses 100 and 300 (in FIGS. 1 and 3). For example, the lens 600 may be 2-10 times larger than the lenses 100 and 300. Moreover, the lens 600 may have a size dependent upon specification application.

In some implementations, relative sizes of the spherical lens 630 and the aspherical-shaped shell 610 may vary. For example, although FIG. 6 may depict relative curvatures and geometries of the spherical lens 630 and the aspherical-shaped shell 610, the spherical lens 630 and the aspherical-shaped shell 610 may have different shapes, curvatures, and geometries.

In some implementations, the lens 600 does not require a capsule in order to maintain a substantially constant pressure within the cavity 640. For example, for larger-sized lenses, thermal expansion or contraction of the viscous fluid 620 within the cavity 640 due to a change of temperatures of the lens 600 is less impactful than with temperature changes of smaller-sized lenses, such as lenses 100 and 300. The associated pressure change in the cavity 640 by the viscous fluid 620 due to the temperature change of the lens 600 may be considered to be substantially negligible in view of the size of the spherical lens 630, the size of the aspherical shell 610, and the volume of viscous fluid 620 within the cavity 640.

Additionally, since the associated pressure change in the cavity 640 by the viscous fluid 620 due to the temperature change of the lens 600 may be substantially negligible, the thickness t1 of the aspherical shell 610 may be reduced, as compared to the aspheric-shaped shell 110 used in lens 100 (in FIG. 1) and the aspheric-shaped shell 310 used in lens 300 (in FIG. 3).

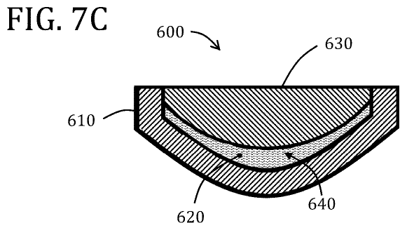

FIGS. 7A-7C are schematic diagrams illustrating an exemplary process for manufacturing the exemplary optical lens of FIG. 6. In FIG. 7A, the viscous fluid 620 is introduced into the aspherical-shaped shell 610, which may be formed using processes similar to those discussed above with respect to FIGS. 1, 4, and 5.

In FIG. 7B, the spherical lens 630 is positioned into an interior of the aspherical-shaped shell 610. As the spherical lens 630 is positioned into the interior of the aspherical-shaped shell 610, the viscous fluid 620 is dispersed to fill an interior cavity 640 between the spherical lens 630 and the aspherical-shaped shell 610. In some implementations, the spherical lens 630 may be bonded with adjoining portions of the aspherical-shaped shell 610. For example, in order to form a seal between the spherical lens 630 and the aspherical-shaped shell 610 an adhesive may be used.

In FIG. 7C, the optical lens 600 is produced that comprises both the spherical lens 630 and the aspherical-shaped shell 610.

In each of FIGS. 1-7, an aspherical-shaped shell is implemented in forming an optical lens, wherein a viscous fluid is provided between aspherical-shaped shell and one of an optical plate (element) and a spherical lens. However, other optical elements may be used in conjunction with the aspherical-shaped shell in order to achieve particular optical properties.

Additionally, in each of FIGS. 1-7, there is depicted a viscous fluid comprising a singular material. However, other configurations may be implemented. For example, a plurality of fluids may be implemented, such as immiscible liquids that each provide different wavelength transmission, density, and/or refractive indices. Alternatively, a plurality of fluids may be implemented, such as miscible solutions that provide different wavelength transmission, density, and/or refractive indices. Moreover, a plurality of fluids may be implemented, such as miscible solutions along with immiscible liquids.

Accordingly, manufacturing costs and time is reduced for larger-sized aspherical-shaped lenses, such that efficiencies for mass production of larger-sized aspheric lenses are improved. Moreover, optical performance of aspherical-shaped lenses is improved with respect to the environments in which the lenses are used.

Unless specific arrangements described herein are mutually exclusive with one another, the various implementations described herein can be combined in whole or in part to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An optical lens, comprising:
an aspheric-shaped shell formed of an optical material;
an optical plate connected to the aspheric-shaped shell; and
a viscous fluid fluidically sealed in a cavity between the aspheric-shaped shell and the optical plate.

2. The optical lens according to claim 1,
wherein the optical plate is bonded to a circumferential region of the aspheric-shaped shell, and
wherein a portion of the circumferential region of the aspheric-shaped shell is spaced apart from the optical plate by a spacing.

3. The optical lens according to claim 2, further comprising a capsule attached to the second end of the aspheric shell within the spacing,
wherein the capsule is in fluid communication with the viscous fluid.

4. The optical lens according to claim 3, wherein the capsule is configured to transport the viscous fluid into and out of the cavity based upon a temperature change of the optical lens.

5. The optical lens according to claim 3, wherein the capsule is configured to maintain a substantially constant pressure within the cavity over a range of operating temperatures of the optical lens.

6. A method for manufacturing an optical lens, comprising:
processing a sheet of optical material to form a plurality of aspheric-shaped shells;
assembling the plurality of aspheric-shaped shells with an optical plate to produce a lens assembly;
processing the lens assembly to produce a lens housing that includes a single one of the aspheric-shaped shells and a portion of the optical plate; and
processing the lens housing by providing a viscous fluid within a cavity between the single one of the aspheric-shaped shells and the portion of the optical plate.

7. The method according to claim 6, wherein the processing a sheet of optical material comprises one of a press molding process and a vacuum molding process.

8. The method according to claim 7, wherein the press molding process comprises:
placing the sheet of optical material between an upper platen and a lower platen;
compressing the sheet of optical material between the upper platen and the lower platen; and
molding the sheet of optical material to form the plurality of aspheric-shaped shells,
wherein an upper surface of the sheet of optical material comprises a contour profile of the upper platen and a lower surface of the sheet of optical material comprises a contour profile of the lower platen.

9. The method according to claim 7, wherein the contour profile of the upper platen compliments the contour profile of the lower platen.

10. The method according to claim 7, wherein the vacuum molding process comprises:
placing the sheet of optical material onto a vacuum plate;
reducing a pressure between the sheet of optical material and the vacuum plate; and
molding the sheet of optical material to form the plurality of aspheric-shaped shells.

11. The method according to claim 10, wherein the molding the sheet of optical material to form the plurality of aspheric-shaped shells includes imparting a plurality of contours of the vacuum plate onto the sheet of optical material.

12. The method according to claim 6, further comprising:
processing the plurality of aspheric-shaped shells to reduce a material thickness of the sheet of optical material at locations between pairs of the aspheric-shaped shells,
wherein the assembling the plurality of aspheric-shaped shells with an optical plate to produce a lens assembly includes bonding the plurality of aspheric-shaped shells to the optical plate at locations other than the locations between pairs of the aspheric shells.

13. The method according to claim 6, further comprising:
providing a capsule to the lens housing,
wherein the capsule includes the viscous fluid.

14. A system for maintaining pressure within an optical element, comprising:
an optical lens comprising:
an aspheric-shaped shell formed of an optical material;
an optical plate connected to the aspheric-shaped shell; and
a viscous fluid fluidically sealed in a cavity between the aspheric-shaped shell and the optical plate; and
a capsule attached to the optical lens, the capsule includes the viscous fluid,
wherein the capsule is configured to maintain a constant pressure within the cavity between the aspheric-shaped shell and the optical plate over a range of operating temperatures of the optical lens.

15. The system according to claim 14, wherein the capsule is configured to maintain a constant pressure within the cavity between the aspheric-shaped shell and the optical plate by transport of the viscous fluid into and out of the cavity based upon a temperature change of the optical lens.

16. The system according to claim 14,
wherein the optical plate is bonded to a circumferential region of the aspheric-shaped shell, and
wherein a portion of the circumferential region of the aspheric-shaped shell is spaced apart from the optical plate by a spacing comprising a portion of the capsule.

17. The system according to claim 16,
wherein the optical lens comprises a spacer disposed between the circumferential region of the aspheric-shaped shell and the optical plate, and
wherein a portion of the capsule is disposed within a channel formed in the spacer.

18. A method for manufacturing an optical lens, comprising:
processing a sheet of optical material to form a plurality of aspheric-shaped shells;
processing the plurality of aspheric-shaped shells to produce individual ones of the aspheric-shaped shells;
processing the individual ones of the aspheric-shaped shells by providing a viscous fluid into the individual ones of the aspheric-shaped shells; and
providing, for each of the individual ones of the aspheric-shaped shells, a spherical lens,
wherein the viscous fluid is within a cavity between the aspheric-shaped shell and the spherical lens.

19. The method according to claim 18, wherein processing a sheet of optical material to form a plurality of aspheric-shaped shells comprises:
placing the sheet of optical material between an upper platen and a lower platen;
compressing the sheet of optical material between the upper platen and the lower platen; and
molding the sheet of optical material to form the plurality of aspheric-shaped shells,
wherein an upper surface of the sheet of optical material comprises a profile of the upper platen and a lower surface of the sheet of optical material comprises a profile of the lower platen.

20. The method according to claim 18, wherein the processing a sheet of optical material to form a plurality of aspheric-shaped shells comprises:
placing the sheet of optical material onto a vacuum plate;
reducing a pressure between the sheet of optical material and the vacuum plate; and
molding the sheet of optical material to form the plurality of aspheric-shaped shells.
